(19) United States
(12) Patent Application Publication
(10) Pub. No.: US 2013/0002654 A1
(43) Pub. Date: Jan. 3, 2013

(54) THREE-DIMENSIONAL GLASSES AND METHOD FOR OPERATING THE SAME

(75) Inventors: Tse-Fan Yeh, Hsin-Chu (TW); Chen-Cheng Chou, Hsin-Chu (TW); Chun-Chieh Chen, Hsin-Chu (TW); Shu-Hui Liao, Hsin-Chu (TW); Jeng-An Liao, Hsin-Chu (TW); Chun-Hao Chen, Hsin-Chu (TW)

(73) Assignee: CORETRONIC CORPORATION, Hsin-Chu (TW)

(21) Appl. No.: 13/436,987

(22) Filed: Apr. 1, 2012

(30) Foreign Application Priority Data
Jul. 1, 2011 (CN) 201110189209.3

(51) Int. Cl. G06T 15/00

(52) U.S. Cl. 345/419

(57) ABSTRACT

A three-dimensional (3D) glasses and a method for operating the same are provided. The 3D glasses includes a first lens, a second lens, an infrared receiver and a control unit. The infrared receiver receives an infrared signal to output a digital control signal. The control unit is coupled to the infrared receiver. The control unit controls a first state of the first lens and a second state of the second lens according to a first pulse of the digital control signal, where at least one of the first state and the second state is an OFF state.

### CROSS-REFERENCE TO RELATED APPLICATION

This application claims the priority benefit of China application serial no. 201110189209.3, filed on Jul. 1, 2011. The entirety of the above-mentioned patent application is hereby incorporated by reference herein and made a part of this specification.

### BACKGROUND OF THE INVENTION

1. Field of the Invention

The invention relates to a three-dimensional (3D) glasses and a method for operating the same. Particularly, the invention relates to a 3D glasses capable of receiving an infrared signal and a method for operating the same.

2. Description of Related Art

Regarding the present display techniques, there are mainly two types of stereo display technique, and one is a stereoscopic-type, which requires a viewer to wear a pair of specially designed glasses, and another one is an auto-stereoscopic type, which can be implemented through the viewer's naked eyes. The stereoscopic-type stereo display technique has been well developed, and is widely used in some special purposes such as military simulations or large-scale entertainments.

Generally, a left lens and a right lens of a 3D glasses are sequentially switched in predetermined timing according to an infrared signal of display apparatus, so as to produce a 3D image in viewer's eyes. In detail, the present 3D glasses receives the infrared signal through a photo diode, and since an output signal of the photo diode is an analog signal, therefore, an amplifier has to be used to amplify the analog signal and convert it into a digital signal for utilization. Moreover, the photo diode is easy to be influenced by an environmental light source, and has a smaller receiving angle and a shorter receiving distance.

U.S. Publication Patent 20100309535 discloses a shutter glasses system, in which a decoder decodes an infrared signal of a control sequence to generate a decoded signal, and a left-eye shutter and a right-eye shutter are turned on and turned off according to the decoded signal. U.S. Pat. No. 6,687,399 discloses a liquid crystal 3D glasses, in which an infrared receiver receives an infrared signal and transmits it to a preamplifier, and a decoder converts an output signal of the receiver into a stereo synchronization signal for controlling the switching of the liquid crystal 3D glasses. U.S. Publication Patent 20100201788 discloses a 3D glasses system, in which a receiver is coupled to a 3D glasses for receiving the data packets sent by a transmitter through infrared signals. Taiwan Patent 305456 discloses a wireless liquid crystal shutter 3D imaging system, in which an external synchronization signal receiver receives a synchronization signal sent by a shutter switching signal transmitter, and in association with an enable/disable signal, a polarity setting signal and a frequency dividing signal, so as to send driving signals respectively to control liquid crystal shutter devices at a left side and a right side of the liquid crystal shutter 3D glasses.

### SUMMARY OF THE INVENTION

The invention is directed to a three-dimensional (3D) glasses and a method for operating the same, in which an infrared receiver is used to convert an infrared signal into a digital control signal, and a left lens and a right lens of the 3D glasses are turned on/off according to the digital control signal, by which programming flexibility and commonality of a signal processing program of the 3D glasses are improved.

Other aspects and advantages of the invention should be further comprehended from the technical features disclosed in the invention.

To achieve one of, a part of or all of the above-mentioned objectives, or to achieve other objectives, an embodiment of the invention provides a three-dimensional (3D) glasses including a first lens, a second lens, an infrared receiver and a control unit. The infrared receiver receives an infrared signal and outputs a digital control signal. The control unit is coupled to the infrared receiver. The control unit controls a first state of the first lens and a second state of the second lens according to a first pulse of the digital control signal, where at least one of the first state and the second state is an OFF state.

To achieve one of, a part of or all of the above-mentioned objectives, or to achieve other objectives, an embodiment of the invention provides a method for operating a 3D glasses, where the 3D glasses includes a first lens and a second lens. The method for operating the 3D glasses includes following steps. An infrared signal is received. A digital control signal is generated according to the infrared signal. A first state of the first lens and a second state of the second lens are controlled according to a first pulse of the digital control signal, where at least one of the first state and the second state is an OFF state.

According to the above descriptions, in the embodiments of the invention, the 3D glasses and the method for operating the same, converts the infrared signal into the digital control signal through the infrared receiver, and the control unit controls the left lens and the right lens of the 3D glasses to be turned on/off according to the digital control signal. In this way, since the digital control signal is easy to be processed, programming flexibility and commonality of a signal processing program of the control unit of the 3D glasses are improved. Moreover, since the infrared receiver has a low cost, the total cost of the 3D glasses is decreased.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system schematic diagram of a pair of three-dimensional (3D) glasses according to an embodiment of the invention.

FIG. 2A is a timing schematic diagram of an infrared signal S_{IR}, a digital control signal S_{DTC}, a left lens and a right lens of FIG. 1 according to an embodiment of the invention.

FIG. 2B is a flowchart illustrating a method for operating a 3D glasses according to an embodiment of the invention.

FIG. 3A is a timing schematic diagram of an infrared signal S_{IR}, a digital control signal S_{DTC}, a left lens and a right lens of FIG. 1 according to another embodiment of the invention.

FIG. 3B is a flowchart illustrating a method for operating a 3D glasses according to another embodiment of the invention.

FIG. 4A is a timing schematic diagram of an infrared signal S_{IR}, a digital control signal S_{DTC}, a left lens and a right lens of FIG. 1 according to still another embodiment of the invention.

FIG. 4B is a flowchart illustrating a method for operating a 3D glasses according to still another embodiment of the invention.

FIG. 4C is a flowchart illustrating a method for operating a 3D glasses according to yet another embodiment of the invention.

### DETAILED DESCRIPTION OF DISCLOSED EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

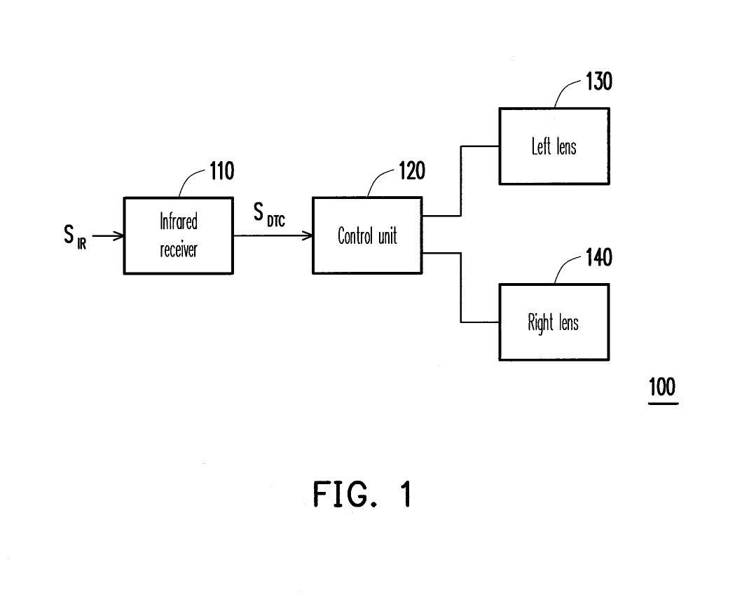

FIG. 1 is a system schematic diagram of a pair of three-dimensional (3D) glasses according to an embodiment of the invention. Referring to FIG. 1, the 3D glasses 100 includes an infrared receiver 110, a control unit 120, a first lens (which is, for example, a left lens 130) and a second lens (which is, for example, a right lens 140). The infrared receiver 110 is used for receiving an infrared signal S_{IR} and outputting a digital control signal S_{DTC}. The infrared signal S_{IR} could be output by a display device (for example, a display or a projector), and the infrared signal S_{IR} could be an infrared signal of a single frequency, for example, the infrared signal S_{IR} could be an infrared signal of 38 kHz or 56 kHz.

The control unit 120 is coupled to the infrared receiver 110. In a frame period, the control unit 120 controls a state (i.e. a first state) of the left lens 130 to be an ON state or an OFF state and controls a state (i.e. a second state) of the right lens 140 to be the ON state or the OFF state according to a pulse of the digital control signal S_{DTC}. The above frame period is a period for displaying a left-eye frame and a right-eye frame, i.e. the frame period at least includes a left-eye frame period and a right-eye frame period, though the invention is not limited thereto. When the 3D glasses 100 is in a using state, at least one of the left lens 130 and the right lens 140 is in the OFF state, and when the 3D glasses 100 is in a non-using state, the left lens 130 and the right lens 140 could be simultaneously in the OFF state or the ON state, which is not limited by the invention.

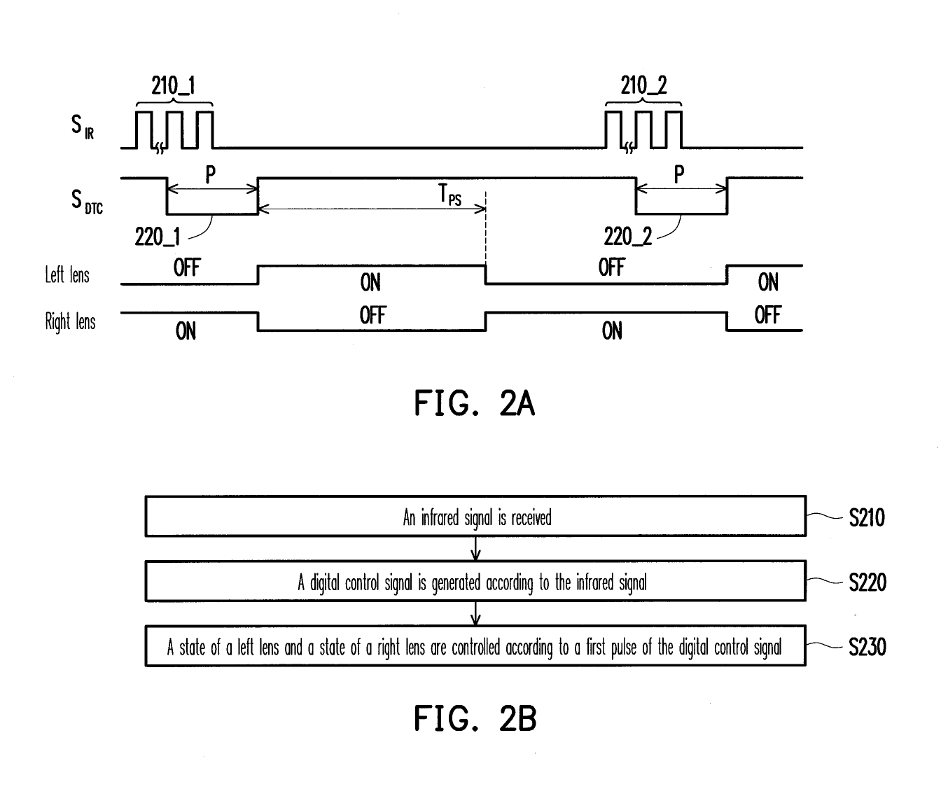

FIG. 2A is a timing schematic diagram of the infrared signal S_{IR}, the digital control signal S_{DTC}, the left lens and the right lens of FIG. 1 according to an embodiment of the invention. Referring to FIG. 1 and FIG. 2A, in the present embodiment, it is assumed that the infrared signal S_{IR} could form a plurality of first pulse trains (for example, 210_1 and 210_2), and the infrared receiver 110 outputs a plurality of first pulses (for example, 220_1 and 220_2) according to the first pulse trains (for example, 210_1 and 210_2). A pulse width of each of the first pulses relates to a pulse number of the corresponding first pulse trains, i.e. a pulse width P of the first pulse 220_1 corresponds to the pulse number of the first pulse train 210_1, the pulse width P of the first pulse 220_2 corresponds to the pulse number of the first pulse train 210_2. For example, when the pulse number of the first pulse train (for example, 210_1 or 210_2) is increased, the pulse width of the first pulse (for example, 220_1 or 220_2) is also increased. Moreover, in the present embodiment, the pulses of the first pulse trains (for example, 210_1 and 210_2) are, for example, positive pulses, and the pulses of the first pulses (for example, 220_1 and 220_2) are, for example, negative pulses, though the invention is not limited thereto.

Moreover, in the present embodiment, it is assumed that one first pulse train (for example, 210_1 or 210_2) is output during one frame period, and the first pulse train (for example, 210_1 or 210_2) could be output when the frame period is started. Therefore, when a frame period is started, the infrared receiver 110 outputs a first pulse (for example, 220_1 or 220_2), and the control unit 120 controls the states of the left lens 130 and the right lens 140 according to the received first pulse (for example, 220_1 or 220_2).

Further, when the control unit 120 receives the first pulse 220_1, it controls the state of the left lens 130 to be the ON state, and controls the state of the right lens 140 to be the OFF state. When the control unit 120 receives the first pulse 220_1 and passes a predetermined time T_{PS}, the control unit 120 controls the state of the left lens 130 to be the OFF state, and controls the state of the right lens 140 to be the ON state. The predetermined time T_{PS} is set to be equal to about a half of a frame period, i.e. the predetermined time T_{PS} is set to be equal to about a left-eye frame period or a right-eye frame period. When the control unit 120 receives the first pulse 220_2, an operation of the control unit 120 is the same as that when it receives the first pulse 220_1, which is not repeated.

Moreover, in the present embodiment, the control unit 120 determines how to control the states of the left lens 130 and the right lens 140 according to whether or not the first pulse (for example, 220_1 or 220_2) is received, i.e. the operation of the control unit 120 is non-related to the pulse widths P of the first pulses (for example, 220_1 and 220_2). Therefore, the pulse widths P corresponding to the first pulses (for example, 220_1 or 220_2) of different frame periods could be different, or the pulse widths P corresponding to the first pulses (for example, 220_1 or 220_2) of different frame periods could be the same, which is not limited by the invention and could be determined by those skilled in the art.

According to the above descriptions, FIG. 2B is a flowchart illustrating a method for operating a 3D glasses according to an embodiment of the invention. Referring to FIG. 2B, in the present embodiment, an infrared signal is first received (step S210), and a digital control signal is generated according to the infrared signal (step S220). Then, a state of the left lens and a state of the right lens are controlled according to a first pulse of the digital control signal (step S230). Details of the above steps can refer to the related descriptions of the embodiment of FIG. 2A, which are not repeated.

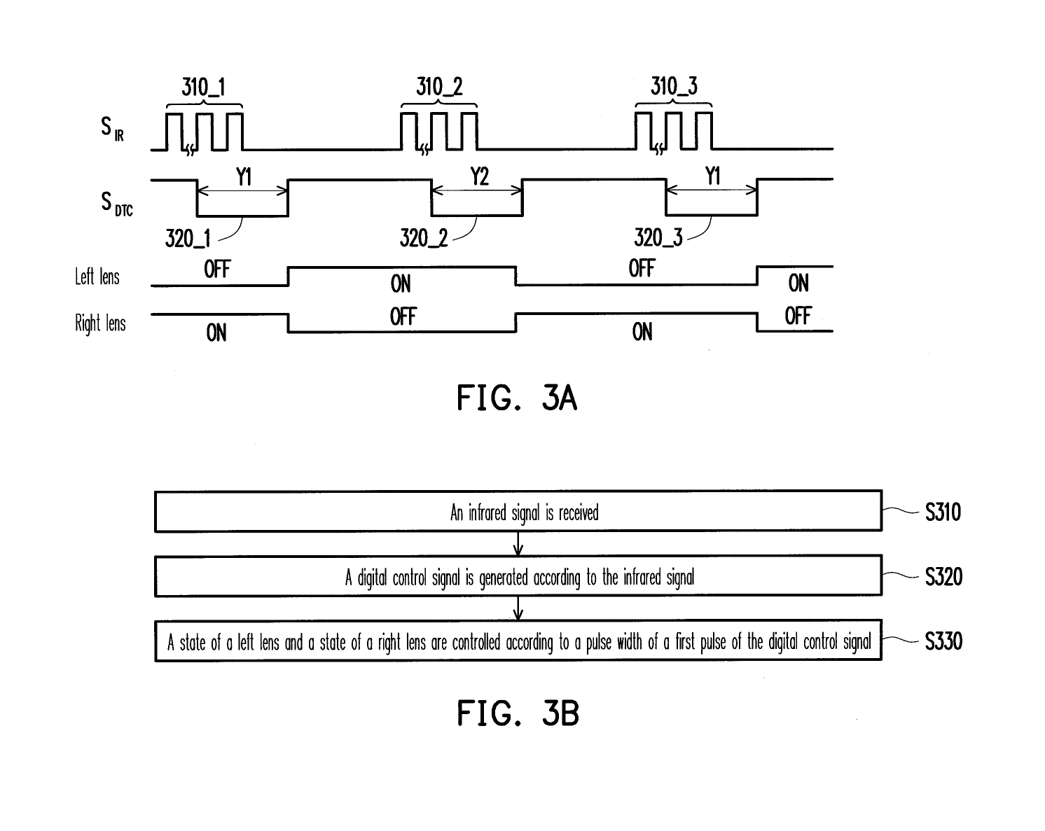

FIG. 3A is a timing schematic diagram of the infrared signal S_{IR}, the digital control signal S_{DTC}, the left lens and the right lens of FIG. 1 according to another embodiment of the invention. Referring to FIG. 1 and FIG. 3A, in the present embodiment, it is assumed that two first pulse trains (for example, 310_{—1-310}_3) are output during one frame period, and the first pulse train (for example, 310_{—1-310}_3) could be output when the corresponding left-eye frame period or the right-eye frame period is started. Therefore, when a left-eye frame period or a right-eye frame period is started, the infrared receiver 110 outputs a first pulse (for example, 320_{—1-320}_3), and the control unit 120 controls the states of the left lens 130 and the right lens 140 according to a pulse width of the received first pulse (for example, 320_{—1-320}_3). The pulse widths of the first pulses 320_{—1-320}_3 respectively correspond to the pulse numbers of the first pulse trains 310_{—1-310}_3.

Moreover, it is set that when the pulse width of the first pulse (for example, 320_{—1-320}_3) is Y1, the state of the left lens 130 is controlled to be the ON state, and the state of the right lens 140 is controlled to be the OFF state. When the pulse width of the first pulse (for example, 320_{—1-320}_3) is Y2, the state of the left lens 130 is controlled to be the OFF state, and the state of the right lens 140 is controlled to be the ON state, where the pulse width Y1 is different to the pulse width Y2.

Further, when the control unit 120 receives the first pulse 320_1, since the pulse width of the first pulse 320_1 is Y1, the control unit 120 controls the state of the left lens 130 to be the ON state, and controls the state of the right lens 140 to be the OFF state. When the control unit 120 receives the first pulse 3202, since the pulse width of the first pulse 320_2 is Y2, the control unit 120 controls the state of the left lens 130 to be the OFF state, and controls the state of the right lens 140 to be the ON state. When the control unit 120 receives the first pulse 3203, since the pulse width of the first pulse 320_3 is Y1, the control unit 120 controls the state of the left lens 130 to be the ON state, and controls the state of the right lens 140 to be the OFF state, and the others could be deduced by analogy, which are not repeated.

Moreover, if the pulse width of the first pulse (for example, 320_{—1-320}_3) is not Y1 or Y2, the control unit 120 could regard the first pulse (for example, 320_1-320_3) as noise, and does not control the states of the left lens 130 and the right lens 140. However, in some embodiments, if the pulse width of the first pulse (for example, 320_1) is close to Y1, the pulse width thereof is regarded as Y1 to execute the corresponding operations, and if the pulse width of the first pulse (for example, 320_2) is close to Y2, the pulse width thereof is regarded as Y2 to execute the corresponding operations. For example, when the pulse width is within a range of 0.8Y1-1.2Y1, it is regarded to be close to Y1, and when the pulse width is within a range of 0.8Y2-1.2Y2, it is regarded to be close to Y2, though the pulse width of a single first pulse cannot be simultaneously close to Y1 and Y2, the above permissive receiving ranges could be adjusted by those skilled in the art.

According to the above descriptions, FIG. 3B is a flowchart illustrating a method for operating a 3D glasses according to another embodiment of the invention. Referring to FIG. 3B, in the present embodiment, an infrared signal is first received (step S310), and a digital control signal is generated according to the infrared signal (step S320). Then, a state of the left lens and a state of the right lens are controlled according to a pulse width of a first pulse of the digital control signal (step S330). Details of the above steps can refer to the related descriptions of the embodiment of FIG. 3A, which are not repeated.

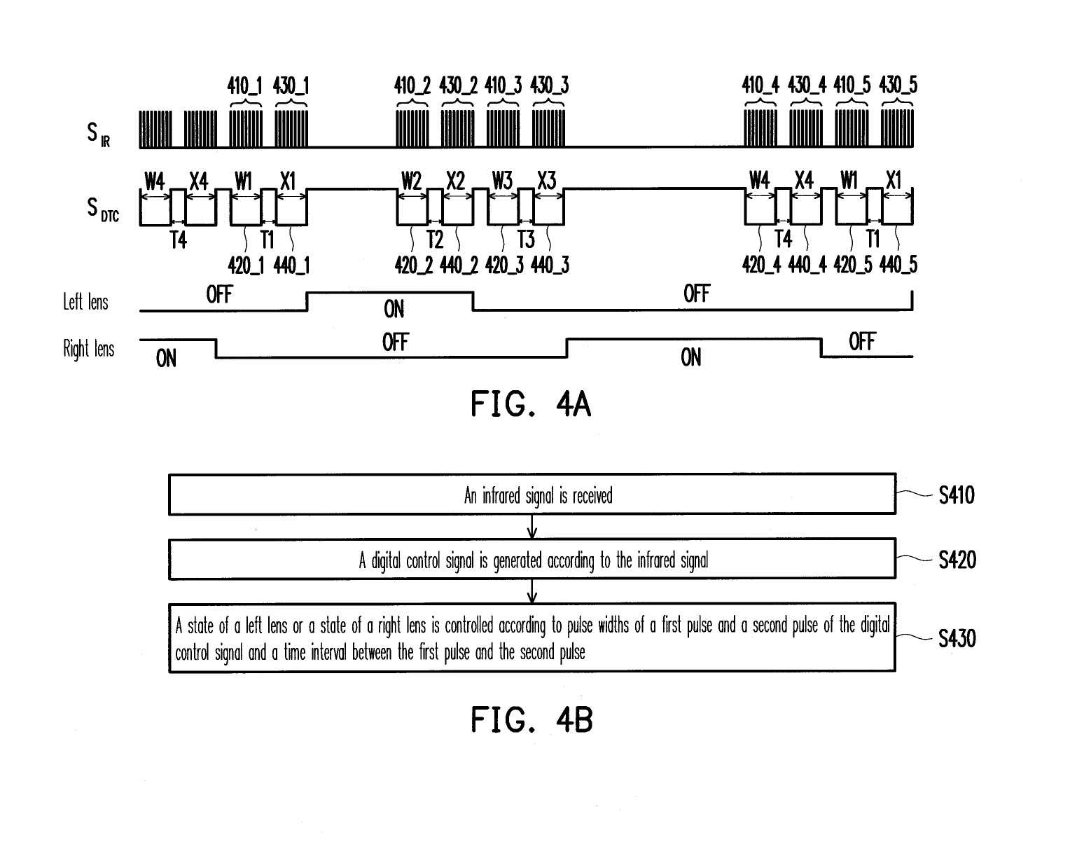

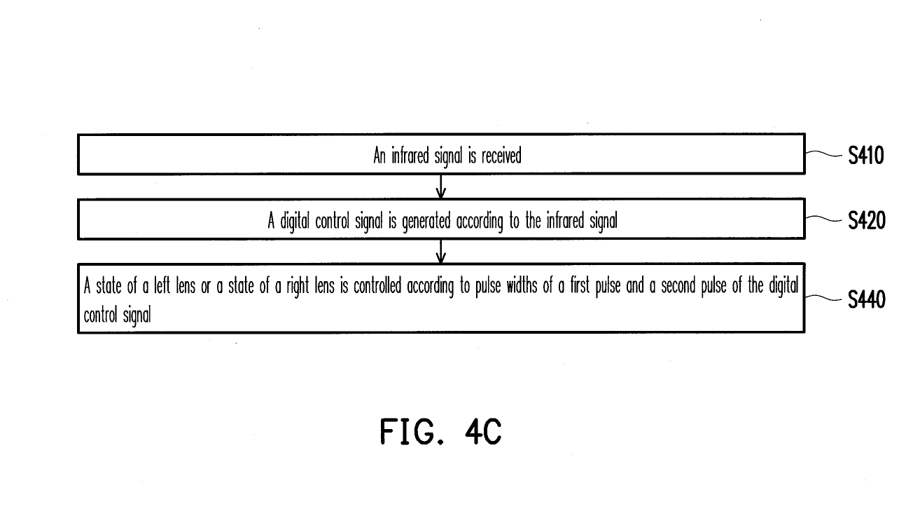

FIG. 4A is a timing schematic diagram of the infrared signal S_{IR}, the digital control signal S_{DTC}, the left lens and the right lens of FIG. 1 according to still another embodiment of the invention. Referring to FIG. 1 and FIG. 4A, in the present embodiment, it is assumed that four first pulse trains (for example, 410_1-410_5) and four second pulse trains (430_{—1-430}_5) are output during one frame period, and the first pulse train (for example, 410_1-410_5) and the corresponding second pulse train (430_1-430_5) could be output when the corresponding left-eye frame period or the right-eye frame period is started or when the corresponding left-eye frame period or the right-eye frame period is to be ended.

For example, when a left-eye frame period is started, the infrared receiver 110 receives the first pulse train 410_1 to output a first pulse 420_1, and receives the second pulse train 430_1 to output a second pulse 440_1, and then the control unit 120 controls the state of the left lens 130 according to a pulse width of the first pulse 420_1, a pulse width of the second pulse 440_1 and a time interval between the first pulse 420_1 and the second pulse 440_1.

When a left-eye frame period is to be ended, the infrared receiver 110 receives the first pulse train 410_2 to output a first pulse 420_2, and receives the second pulse train 430_2 to output a second pulse 440_2, and then the control unit 120 controls the state of the left lens 130 according to a pulse width of the first pulse 420_2, a pulse width of the second pulse 440_2 and a time interval between the first pulse 420_2 and the second pulse 440_2.

When a right-eye frame period is started, the infrared receiver 110 receives the first pulse train 410_3 to output a first pulse 420_3, and receives the second pulse train 430_3 to output a second pulse 440_3, and then the control unit 120 controls the state of the right lens 140 according to a pulse width of the first pulse 420_3, a pulse width of the second pulse 440_3 and a time interval between the first pulse 420_3 and the second pulse 440_3.

When a right-eye frame period is to be ended, the infrared receiver 110 receives the first pulse train 410_4 to output a first pulse 420_4, and receives the second pulse train 430_4 to output a second pulse 440_4, and then the control unit 120 controls the state of the right lens 140 according to a pulse width of the first pulse 420_4, a pulse width of the second pulse 440_4 and a time interval between the first pulse 420_4 and the second pulse 440_4.

The pulse widths of the first pulses 420_{—1-420}_5 respectively correspond to pulse numbers of the first pulse trains 410_{—1-410}_5, and the pulse widths of the second pulses 440_1-440_5 respectively correspond to pulse numbers of the second pulse trains 430_1-430_5.

It is set that when a pulse width of the first pulse (for example, 420_1-420_5) is W1, a pulse width of the corresponding second pulse (for example, 440_{—1-440}_5) is X1, and a time interval between the first pulse and the corresponding second pulse is T1, the state of the left lens 130 is controlled to be the ON state. When a pulse width of the first pulse (for example, 420_{—1-420}_5) is W2, a pulse width of the corresponding second pulse (for example, 440_{—1-440}_5) is X2, and a time interval between the first pulse and the corresponding second pulse is T2, the state of the left lens 130 is controlled to be the OFF state. When a pulse width of the first pulse (for example, 420_1-420_5) is W3, a pulse width of the corresponding second pulse (for example, 440_1-440_5) is X3, and a time interval between the first pulse and the corresponding second pulse is T3, the state of the right lens 140 is controlled to be the ON state. When a pulse width of the first pulse (for example, 420_{—1-420}_5) is W4, a pulse width of the corresponding second pulse (for example, 440_{—1-440}_5) is X4, and a time interval between the first pulse and the corresponding second pulse is T4, the state of the right lens 140 is controlled to be the OFF state.

A combination of W1, X1 and T1, a combination of W2, X2 and T2, a combination of W3, X3 and T3, and a combination of W4, X4 and T4 are different to each other. The combination of W1, X1 and T1 and the combination of W2, X2 and T2 are taken as an example, when one of the following conditions that W1 is not equal to W2, X1 is not equal to X2 and T1 is not equal to T2 is satisfied, the combination of W1, X1 and T1 and the combination of W2, X2 and T2 are regarded to be different, and definitions of the other combinations can be deduced by analogy, which are not repeated.

Further, when the control unit 120 receives the first pulse 420_1 and the second pulse 440_1, since the pulse width of the first pulse 420_1 is W1, the pulse width of the second pulse 440_1 is X1, and the time interval between the first pulse 420_1 and the second pulse 440_1 is T1, the control unit 120 controls the state of the left lens 130 to be the ON state. When the control unit 120 receives the first pulse 420_2 and the second pulse 4402, since the pulse width of the first pulse 420_2 is W2, the pulse width of the second pulse 440_2 is X2, and the time interval between the first pulse 4202 and the second pulse 440_2 is T2, the control unit 120 controls the state of the left lens 130 to be the OFF state.

When the control unit 120 receives the first pulse 420_3 and the second pulse 440_3, since the pulse width of the first pulse 420_3 is W3, the pulse width of the second pulse 440_3 is X3, and the time interval between the first pulse 420_3 and the second pulse 440_3 is T3, the control unit 120 controls the state of the right lens 140 to be the ON state. When the control unit 120 receives the first pulse 420_4 and the second pulse 440_4, since the pulse width of the first pulse 4204 is W4, the pulse width of the second pulse 440_4 is X4, and the time interval between the first pulse 420_4 and the second pulse 440_4 is T4, the control unit 120 controls the state of the right lens 140 to be the OFF state, and the others can be deduced by analogy, which are not repeated.

Moreover, if the pulse widths of the first pulse (for example, 420_{—1-420}_5) and the corresponding second pulse (for example, 440_{—1-440}_5) and the time interval between the first pulse and the second pulse are not one of the combination of W1, X1 and T1, the combination of W2, X2 and T2, the combination of W3, X3 and T3, and the combination of W4, X4 and T4, the control unit 120 can regard the first pulse (for example, 420_{—1-420}_5) and the corresponding second pulse (for example, 440_{—1-440}_5) as noises, and does not control the states of the left lens 130 an the right lens 140. However, in some embodiments, if the pulse width of the first pulse (for example, 420_1) is close to W1, the pulse width thereof is regarded as W1; and if the pulse width of the first pulse (for example, 420_2) is close to W2, the pulse width thereof is regarded as W2, and the others are deduced by analogy, and the pulse widths of the second pulses (for example 440_{—1-440}_5) and the time intervals between the first pulses and the second pulses could also be determined in the same way.

According to the above descriptions, FIG. 4B is a flowchart illustrating a method for operating a 3D glasses according to still another embodiment of the invention. Referring to FIG. 4B, in the present embodiment, an infrared signal is first received (step S410), and a digital control signal is generated according to the infrared signal (step S420). Then, a state of the left lens or a state of the right lens is controlled according to pulse widths of a first pulse and a second pulse of the digital control signal and a time interval between the first pulse and the second pulse (step S430). Details of the above steps can refer to the related descriptions of the embodiment of FIG. 4A, which are not repeated.

Referring to FIG. 1 and FIG. 4A, in other embodiments, the control unit 120 could control the state of the left lens 130 or the state of the right lens 140 according to the pulse widths of the first pulse (for example, 420_{—1-420}_5) and the corresponding second pulse (for example, 440_{—1-440}_5), i.e. the control unit 120 does not operate according to the time interval between the first pulse and the corresponding second pulse. Moreover, the related settings of FIG. 4A are used herein.

Further, when the control unit 120 receives the first pulse 420_1 and the second pulse 440_1, since the pulse width of the first pulse 420_1 is W1 and the pulse width of the second pulse 440_1 is X1, the control unit 120 controls the state of the left lens 130 to be the ON state. When the control unit 120 receives the first pulse 420_2 and the second pulse 440_2, since the pulse width of the first pulse 420_2 is W2 and the pulse width of the second pulse 440_2 is X2, the control unit 120 controls the state of the left lens 130 to be the OFF state.

When the control unit 120 receives the first pulse 420_3 and the second pulse 440_3, since the pulse width of the first pulse 420_3 is W3 and the pulse width of the second pulse 440_3 is X3, the control unit 120 controls the state of the right lens 140 to be the ON state. When the control unit 120 receives the first pulse 420_4 and the second pulse 4404, since the pulse width of the first pulse 420_4 is W4 and the pulse width of the second pulse 440_4 is X4, the control unit 120 controls the state of the right lens 140 to be the OFF state, and the others can be deduced by analogy, which are not repeated.

According to the above descriptions, FIG. 4C is a flowchart illustrating a method for operating a 3D glasses according to yet another embodiment of the invention. Referring to FIG. 4B and FIG. 4C, a difference there between is the step S440, and in the step S440, a state of the left lens or a state of the right lens is controlled according to pulse widths of a first pulse and a second pulse of the digital control signal. Details of the above steps can refer to the related descriptions of the aforementioned embodiment, which are not repeated.

In summary, in the embodiments of the invention, the 3D glasses and the method for operating the same, convert the infrared signal into the digital control signal through the infrared receiver, and the control unit controls the left lens and the right lens of the 3D glasses to be turned on/off according to the digital control signal. In this way, since the digital control signal is easy to be processed, programming flexibility and commonality of a signal processing program of the control unit of the 3D glasses are improved. Moreover, since the infrared receiver used for receiving single-frequency infrared has a low cost, the total cost of the 3D glasses is decreased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. In addition, the first lens, the second lens, the first pulse and the second pulse, etc. mentioned in the specification are used to represent the terminologies of the components/devices, and not used to limit the upper or lower bound of the number of the components/devices.

What is claimed is:

1. A three-dimensional (3D) glasses, comprising:
a first lens and a second lens;
an infrared receiver, used for receiving an infrared signal to output a digital control signal; and
a control unit, coupled to the infrared receiver, wherein the control unit controls a first state of the first lens and a second state of the second lens according to a first pulse of the digital control signal, wherein at least one of the first state and the second state is an OFF state.

2. The 3D glasses as claimed in claim 1, wherein the digital control signal further comprises a second pulse, and the control unit controls the first state of the first lens or the second state of the second lens according to pulses widths of the first pulse and the second pulse.

3. The 3D glasses as claimed in claim 2, wherein when the pulse widths of the first pulse and the second pulse are respectively W1 and X1, the first state of the first lens is controlled to be an ON state, when the pulse widths of the first pulse and the second pulse are respectively W2 and X2, the first state of the first lens is controlled to be the OFF state, when the pulse widths of the first pulse and the second pulse are respectively W3 and X3, the second state of the second lens is controlled to be the ON state, and when the pulse widths of the first pulse and the second pulse are respectively W4 and X4, the second state of the second lens is controlled to be the OFF state, wherein a combination of W1 and X1, a combination of W2 and X2, a combination of W3 and X3, and a combination of W4 and X4 are different.

4. The 3D glasses as claimed in claim 2, wherein the pulse width of the first pulse corresponds to a pulse number of a first pulse train of the infrared signal, and the pulse width of the second pulse corresponds to a pulse number of a second pulse train of the infrared signal.

5. The 3D glasses as claimed in claim 2, wherein the control unit controls the first state of the first lens or the second state of the second lens according to the pulses widths of the first pulse and the second pulse and a time interval between the first pulse and the second pulse.

6. The 3D glasses as claimed in claim 5, wherein when the pulse widths of the first pulse and the second pulse are respectively W1 and X1 and the time interval is T1, the first state of the first lens is controlled to be the ON state, when the pulse widths of the first pulse and the second pulse are respectively W2 and X2 and the time interval is T2, the first state of the first lens is controlled to be the OFF state, when the pulse widths of the first pulse and the second pulse are respectively W3 and X3 and the time interval is T3, the second state of the second lens is controlled to be the ON state, and when the pulse widths of the first pulse and the second pulse are respectively W4 and X4 and the time interval is T4, the second state of the second lens is controlled to be the OFF state, wherein a combination of W1, X1 and T1, a combination of W2, X2 and T2, a combination of W3, X3 and T3, and a combination of W4, X4 and T4 are different.

7. The 3D glasses as claimed in claim 1, wherein when the control unit receives the first pulse, the control unit controls the first state of the first lens to be an ON state, and controls the second state of the second lens to be the OFF state, and when the control unit receives the first pulse and passed a predetermined time, the control unit controls the first state of the first lens to be the OFF state, and controls the second state of the second lens to be the ON state.

8. The 3D glasses as claimed in claim 7, wherein the predetermined time is equal to a half of one frame period.

9. The 3D glasses as claimed in claim 7, wherein in different frame periods, the pulse width of the first pulse is the same.

10. The 3D glasses as claimed in claim 1, wherein when a pulse width of the first pulse is Y1, the first state of the first lens is controlled to be an ON state, and the second state of the second lens is controlled to be the OFF state, and when the pulse width of the first pulse is Y2, the first state of the first lens is controlled to be the OFF state, and the second state of the second lens is controlled to be the ON state, wherein Y1 and Y2 are different.

11. The 3D glasses as claimed in claim 1, wherein the infrared signal corresponds to a single frequency.

12. The 3D glasses as claimed in claim 11, wherein the frequency is one of 38 kHz and 56 kHz.

13. A method for operating a 3D glasses, wherein the 3D glasses comprises a first lens and a second lens, the method for operating the 3D glasses comprising:
receiving an infrared signal;
generating a digital control signal according to the infrared signal; and
controlling a first state of the first lens and a second state of the second lens according to a first pulse of the digital control signal, wherein at least one of the first state and the second state is an OFF state.

14. The method for operating the 3D glasses as claimed in claim 13, wherein the step of controlling the first state of the first lens and the second state of the second lens according to the first pulse of the digital control signal comprises:
controlling the first state of the first lens or the second state of the second lens according to pulses widths of the first pulse and a second pulse of the digital control signal.

15. The method for operating the 3D glasses as claimed in claim 14, wherein the step of controlling the first state of the first lens or the second state of the second lens according to the pulses widths of the first pulse and the second pulse of the digital control signal comprises:
when the pulse widths of the first pulse and the second pulse are respectively W1 and X1, controlling the first state of the first lens to be an ON state;
when the pulse widths of the first pulse and the second pulse are respectively W2 and X2, controlling the first state of the first lens to be the OFF state;
when the pulse widths of the first pulse and the second pulse are respectively W3 and X3, controlling the second state of the second lens to be the ON state; and
when the pulse widths of the first pulse and the second pulse are respectively W4 and X4, controlling the second state of the second lens to be the OFF state,
wherein a combination of W1 and X1, a combination of W2 and X2, a combination of W3 and X3, and a combination of W4 and X4 are different.

16. The method for operating the 3D glasses as claimed in claim 13, wherein the step of controlling the first state of the first lens and the second state of the second lens according to the first pulse of the digital control signal comprises:
controlling the first state of the first lens or the second state of the second lens according to the pulses widths of the first pulse and the second pulse of the digital control signal and a time interval between the first pulse and the second pulse.

17. The method for operating the 3D glasses as claimed in claim 16, wherein the step of controlling the first state of the first lens or the second state of the second lens according to the pulses widths of the first pulse and the second pulse of the digital control signal and the time interval between the first pulse and the second pulse comprises:
when the pulse widths of the first pulse and the second pulse are respectively W1 and X1 and the time interval is T1, controlling the first state of the first lens to be an ON state;
when the pulse widths of the first pulse and the second pulse are respectively W2 and X2 and the time interval is T2, controlling the first state of the first lens to be the OFF state;
when the pulse widths of the first pulse and the second pulse are respectively W3 and X3 and the time interval is T3, controlling the second state of the second lens to be the ON state; and
when the pulse widths of the first pulse and the second pulse are respectively W4 and X4 and the time interval is T4, controlling the second state of the second lens to be the OFF state,
wherein a combination of W1, X1 and T1, a combination of W2, X2 and T2, a combination of W3, X3 and T3, and a combination of W4, X4 and T4 are different.

18. The method for operating the 3D glasses as claimed in claim 13, wherein the step of controlling the first state of the first lens and the second state of the second lens according to the first pulse of the digital control signal comprises:
when the first pulse is received, controlling the first state of the first lens to be an ON state, and controlling the second state of the second lens to be the OFF state; and
when the first pulse is received and a predetermined time is passed, controlling the first state of the first lens to be the OFF state, and controlling the second state of the second lens to be the ON state.

19. The method for operating the 3D glasses as claimed in claim 18, wherein the predetermined time is equal to a half of one frame period.

20. The method for operating the 3D glasses as claimed in claim 13, wherein the step of controlling the first state of the first lens and the second state of the second lens according to the first pulse of the digital control signal comprises:
when a pulse width of the first pulse is Y1, controlling the first state of the first lens to be an ON state, and controlling the second state of the second lens to be the OFF state; and
when the pulse width of the first pulse is Y2, controlling the first state of the first lens to be the OFF state, and controlling the second state of the second lens to be the ON state,
wherein Y1 and Y2 are different.
